(19) United States
(12) Patent Application Publication
(10) Pub. No.: US 2002/0024599 A1
(43) Pub. Date: Feb. 28, 2002

(54) Moving object tracking apparatus

(76) Inventors: Yoshio Fukuhara, Niiza (JP); Kiyoshi Kumata, Kyotanabe (JP); Shinichi Tanaka, Nara (JP)

Correspondence Address: Dike, Bronstein, Roberts & Cushman, Intellectual Property Practice Group, Edwards & Angell, LLP, 130 Water Street, Boston, MA, 02109, US

(21) Appl. No.: 09/931,962

(22) Filed: Aug. 16, 2001

(30) Foreign Application Priority Data
Aug. 17, 2000 (JP) 2000-247885

(51) Int. Cl. H04N 7/00

(52) U.S. Cl. 348/169; 348/36; 348/170; 348/171; 348/172; 348/155

(57) ABSTRACT

A moving object tracking apparatus for detecting and tracking one or more moving objects in an environment is provided. The moving object tracking apparatus comprises an optical system including a hyperboloidal mirror for capturing visual field information on a 360° environment, a single stationary camera for converting the captured visual field information to image information, and an information processing section for processing the image information. The information processing section detects and tracks the one or more moving objects based on the image information.

### BACKGROUND OF THE INVENTION

1. Field of the Invention

The present invention relates to a moving object tracking apparatus for automatically tracking a moving object in the environment, in which visual field information on an environment is captured using a video camera or the like and the captured image information is processed using an image processing technique to detect the moving object.

2. Description of the Related Art

Recently, in the field of surveillance cameras for surveillance of intruders in a dangerous area or prevention of collision of a mobile device, attention has been focused on a moving object tracking apparatus for automatically tracking a moving object in an environment, in which visual field information on the environment is captured using a video camera or the like and the captured image information is processed using an image processing technique to detect the moving object. Conventionally, a camera itself follows a moving object.

For example:

(1) Japanese Laid-Open Publication No. 8-9227 discloses an image capturing apparatus having an automatic tracking function-in which a single camera capable of changing a viewing angle (e.g., pan, tilt and zoom capabilities) is rotated depending on the motion of a moving object so as to track the moving object.

(2) Japanese Laid-Open Publication No. 7-114642 discloses a moving object measuring apparatus in which, in order to smooth the tracking of the a camera described in (1) above, the position of a moving object is predicted, and a target value which is calculated based on the predicted position is provided to means for driving the camera.

(3) Japanese Laid-Open Publication No. 9-322052 discloses a tracking apparatus using a plurality of cameras (an automatic photographing camera system) in which two cameras called “sensor cameras” are used to determine the coordinates of a moving object according to the principle of trigonometrical survey. The cameras are controlled (e.g., panned, tilted or zoomed) in accordance with the coordinates so as to track the moving object.

However, the above-described apparatus (1) does not function unless a moving object is present in the viewing angle of the camera, so that when a target moving object moves fast and goes outside the viewing angle of the camera, the apparatus cannot track the moving object. Although the above-described apparatus (2) has a better tracking performance the apparatus (1), a high-performance and high-speed camera controlling device is required. The above-described apparatus (3) employs a plurality of cameras so as to capture a wide range of information on the environment and therefore has an enhanced tracking performance. However, the use of a plurality of cameras increases the cost of the system and further a control circuit for controlling the cameras is accordingly complex.

In any case, if a camera is rotated, the tracking speed is limited as described above and an image captured simultaneously is restricted by the viewing angle of the camera so that a blind spot exists. Moreover, since a mechanical driving portion for rotating a camera is required, it is necessary to maintain the mechanical driving portion when operated for a long time.

There has been proposed a method using a rotating mirror for capturing images in all directions simultaneously without a mechanical driving portion. Among other things, a method using a hyperboloidal mirror can convert an input image to an image viewed from the focus of the mirror (a perspective projection image substantially equivalent to an image taken by a typical camera) or an image obtained by rotating a camera around a vertical axis (a cylinder-shaped panoramic image). Therefore, such a method can perform various kinds of image processing compared to methods employing mirrors having other shapes. Such an omnidirectional visual system employing the hyperboloidal mirror is disclosed in Japanese Laid-Open Publication No. 6-295333.

### SUMMARY OF THE INVENTION

According to one aspect of the present invention, a moving object tracking apparatus for detecting and tracking one or more moving objects in an environment, comprises an optical system including a hyperboloidal mirror for capturing visual field information on a 360° environment, a single stationary camera for converting the captured visual field information to image information, and an information processing section for processing the image information. The information processing section detects and tracks the one or more moving objects based on the image information.

According to the above-described features, a visual field information on an 360° environment can be captured by an optical system including a hyperboloidal mirror. The visual field information obtained by the optical system is converted to image information using a single stationary camera (which is not rotated). By processing such image information, a moving object in the environment can be detected and tracked. Therefore, it is possible to realize a tracking apparatus including a single camera without a mechanical portion, in which a blind spot does not occur. In conventional moving object tracking apparatuses, a camera itself needs to be mechanically operated (e.g., pan and tilt), or a plurality of cameras need to be switched. In contrast, according to the present invention, the above-described problems can be solved by use of a hyperboloidal mirror, thereby making it possible to realize a moving object tracking apparatus having low cost and high precision capabilities. For example, as described later, data of each moving object is labeled so as to be managed and identified when the moving object is detected by image processing. Thereby, one or more moving objects in an image can be tracked.

In one embodiment of this invention, the image information includes all-direction image information. The information processing section converts at least a portion of the all-direction image information to panoramic image information. The information processing section provides a marker to each of the one or more moving objects in the panoramic image information.

According to the above-described feature, an all-direction image of a 360° environment can be easily viewed using a panoramic image. By using a marker, identification of a moving object is made easier.

In one embodiment of this invention, the information processing section provides a marker to each of the one or more moving objects depending on a size of each of the one or more moving objects.

According to the above-described feature, a range of an image in which an attempt is made to detect a moving object can be clearly defined by changing the size of a marker.

In one embodiment of this invention, the image information includes all-direction image information, and the information processing section converts at least a portion of the all-direction image information to perspective projection image information.

According to the above-described feature, captured image information is converted to a perspective projection image which is an image viewed from a focus of a hyperboloidal mirror. Therefore, an image without distortion due to the hyperboloidal mirror can be obtained.

In one embodiment of this invention, the information processing section processes the image information using a previously prepared table.

According to the above-described feature, image conversion can be sped up by using previously prepared table.

In one embodiment of this invention, the information processing section processes the image information using only one kind of data out of RGB data in the image information.

According to the above-described feature, since only one kind of data of RGB data is used in image processing, the amount of the image processing is reduced. Therefore, the image processing can be sped up.

In one embodiment of this invention, the information processing section detects the one or more moving objects based on a brightness difference between predetermined frame information of the image information and frame information previous to the predetermined frame information of the image information.

Thus, the invention described herein makes possible the advantages of providing a moving object tracking apparatus using an optical system employing a hyperboloidal mirror in which 360° visual field information on an environment is captured, where a moving object is detected from the captured image information using an image processing technique so as to be tracked. Therefore, a mechanical driving portion is not required and there is not blind spot present in the moving object tracking apparatus.

These and other advantages of the present invention will become apparent to those skilled in the art upon reading and understanding the following detailed description with reference to the accompanying figures.

### BRIEF DESCRIPTION OF THE DRAWINGS

FIG. 1 is a diagram showing a moving object tracking apparatus according to an example of the present invention.

FIG. 2 is a diagram showing an all-direction image including visual field information on the 360° environment displayed on a display screen in an example of the present invention.

FIG. 3 is a diagram showing an image obtained by subjecting an all-direction image to panorama conversion in an example of the present invention.

FIG. 4 is a diagram showing a perspective projection image in an example of the present invention.

FIGS. 5A and 5B are diagrams for explaining a pan operation in a perspective projection image in an example of the present invention.

FIG. 6 is a diagram for explaining a positional relationship between a hyperboloidal mirror and a camera in an optical system in an example of the present invention.

FIG. 7 is a diagram showing a moving object tracking apparatus according to an example of the present invention.

FIG. 8 is a diagram showing an image processing board in an example of the present invention.

FIG. 9 is a diagram showing an all-direction image displayed on a display screen of a personal computer in an example of the present invention.

FIG. 10 is a diagram showing an all-direction image, a panoramic image, and a perspective projection image displayed on a display screen of a personal computer in an example of the present invention.

FIG. 11 is a flowchart for explaining a process flow according to which a moving object is detected in an all-direction image, a marker is given to the moving object, and panorama conversion and perspective projection conversion are performed in an example of the present invention.

FIG. 12 is a diagram for explaining a coordinate system of an all-direction image in an example of the present invention.

FIGS. 13A and 13B are diagrams for explaining conversion from an all-direction image to a panoramic image in an example of the present invention.

FIGS. 14A and 14B are diagrams for explaining conversion from an all-direction image to a perspective projection image in an example of the present invention.

FIG. 15 is a diagram showing how an object is projected by a hyperboloidal mirror in an example of the present invention.

### DESCRIPTION OF THE PREFERRED EMBODIMENTS

Hereinafter, the present invention will be described by way of illustrative examples with reference to the accompanying drawings.

A moving object tracking apparatus according to the present invention employs an optical system using a hyperboloidal mirror for capturing 360° visual field information, in which the visual field information obtained by the optical system is converted into image information by a camera, and a moving object is detected and tracked using an image processing technique.

Typically, the term “image” refers to a still picture, and the term “video” refers to a moving picture. “Video” consists of a plurality of still pictures, so “video” is herein included as a kind of “image”. The present invention can capture images in all directions simultaneously in real time. “Image” may be herein included as a kind of “video”.

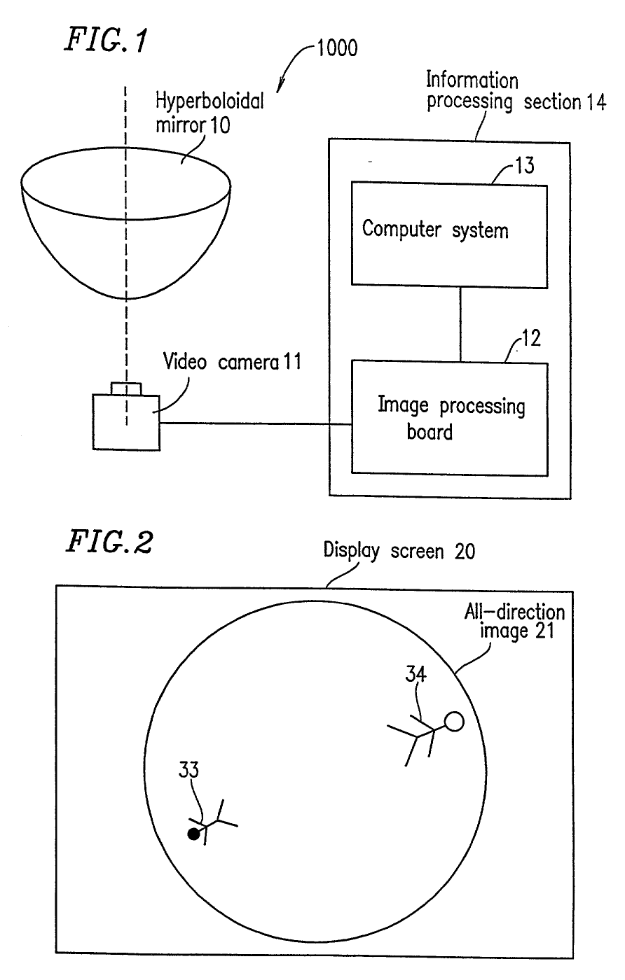

FIG. 1 is a block diagram showing a schematic configuration of a moving object tracking apparatus 1000 according to an example of the present invention. The moving object tracking apparatus 1000 includes a hyperboloidal mirror 10, a video camera 11, and an information processing section 14. The information processing section 14 includes an image processing board 12 and a computer system 13. In the moving object tracking apparatus 1000, the hyperboloidal mirror 10 capable of obtaining 360° visual field information is used as an optical system, and video of the environment obtained by the optical system is converted to image information by the video camera 11. The image information is converted to digital information by an image processing board 12, and the digital information is stored in a memory of a computer system 13. The digital information is subjected to image processing as described later, thereby detecting and tracking a moving object.

FIG. 2 shows a display screen 20 of the computer system 13 which displays the digital information obtained by capturing, using the video camera 11, an all-direction image 21 of the 360° environment obtained by the hyperboloidal mirror 10 and converting by the image processing board 12. Thus, video (image) of the 360° environment (i.e., a certain range of image projected on the hyperboloidal mirror 10) can be captured simultaneously in real time. Moving objects are detected using image processing as described later, and the data of each moving object are labeled so as to be managed and identified. Therefore, one or more moving objects included in an image can be tracked.

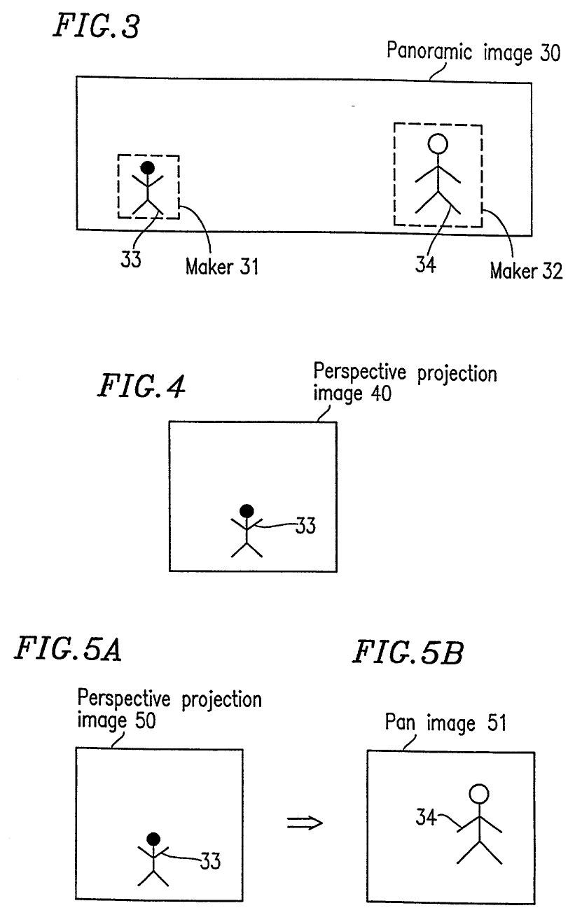

FIG. 3 is a panoramic image 30 obtained by subjecting the 360° all-direction image of FIG. 2 to image processing described later (panorama conversion) in order to make it easy to view the 360° all-direction image. With the panoramic image 30, video (i.e., image) of the 360° environment can be seen simultaneously. Moving objects 33 and 34 detected in the panoramic image 30 are subjected to image processing as described later to give the moving objects 33 and 34 respective markers 31 and 32, thereby making it easy to identify the moving objects 33 and 34. Further, once the sizes of the markers 31 and 32 are determined depending on the areas of the moving objects 33 and 34 detected in the panoramic image 30, it is easier to identify the moving objects 33 and 34.

The panoramic image 30 is an image obtained by developing (spreading out) the all-direction video obtained by the hyperboloidal mirror 10 in a θ direction, and includes distortion due to the hyperboloidal mirror 10. Therefore, the panoramic image 30 is subjected to image processing as described later to be converted into a perspective projection image 40 which is an image viewed from a focus of the hyperboloidal mirror 10 as shown in FIG. 4 (an image photographed by a typical camera), thereby obtaining an image without distortion. Algorithms for panorama conversion and perspective projection conversion for images obtained by the hyperboloidal mirror 10 are disclosed Japanese Laid-Open Publication No. 6-295333, for example.

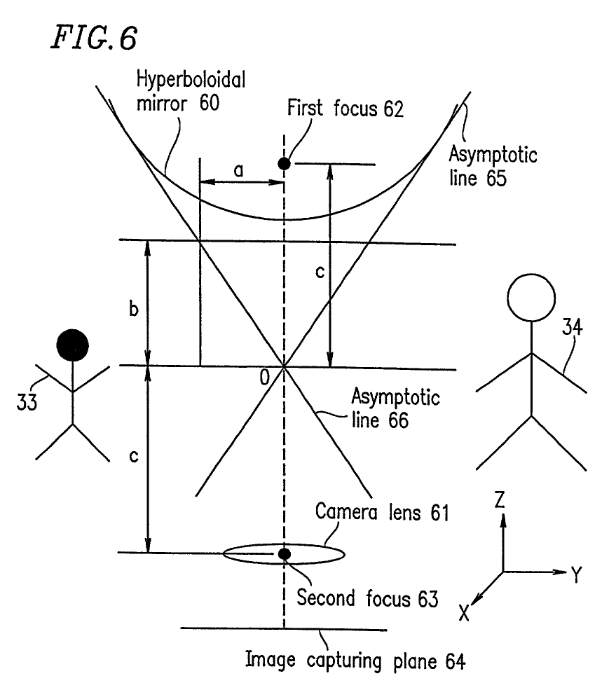

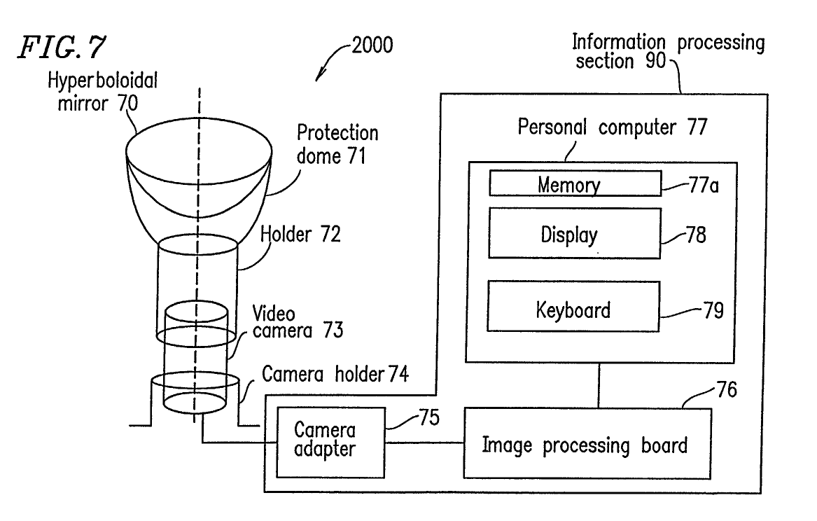

The perspective projection image 40 of FIG. 4 is an image without distortion converted from the all-direction image 21 of FIG. 2, and is also regarded as an image cut from the panoramic image 30 of FIG. 3. Therefore, by changing portions to be cut off the panoramic image 30 using an image processing technique as described later, operations equivalent to pan and tilt can be performed without moving a camera as shown in FIGS. 5A and 5B. FIG. 5A is a perspective projection image 50 and FIG. 5B is a perspective projection image 51 after a pan operation.

As described above, algorithms for panorama conversion and perspective projection conversion for images obtained by the hyperboloidal mirror 10 are disclosed in Japanese Laid-Open Publication No. 6-295333, for example. However, calculation of conversion formulas described in this publication is excessively time-consuming, so that image processing cannot be performed in real time. Therefore, in the present invention data required for the conversion formulas are previously prepared, by an amount corresponding to the number of pixels of a display (i.e., the resolution of a captured image), in a memory of the computer system 13 or the like as a table. As the conversion is needed, the calculation results of the conversion formulas are read out from the table without calculation, making it possible to speed up the image processing.

Further, when the all-direction video obtained by the hyperboloidal mirror 10 is converted to digital information by the image processing board 12 as described above, three kinds of data (R, G and B) on color video are obtained when a video camera captures color images. The image processing described later may not be performed for all three kinds of data (R, G and B), and, for example, only one kind of data (e.g., R) is used to detect a moving object, thereby reducing the amount of image processing and therefore speeding up the processing. For example, the all-direction image 21 shown in FIG. 2 is obtained by processing only R data.

Hereinafter, an example of the present invention will be described in more detail.

Details of the omnidirectional visual system employing the hyperboloidal mirror 10 used as the optical system of the present invention is disclosed in Japanese Laid-Open Publication No. 6-295333. As shown in FIG. 6, the center of a camera lens 61 of an image capturing section (i.e., the video camera 11) is positioned at a second focus 63 opposite a first focus 62 of a hyperboloidal mirror 60 (corresponding to the hyperboloidal mirror 10 of FIG. 1), and an image capturing plane 64 of the image capturing section is positioned a focal distance of the camera lens 61 away from the camera lens 61. Therefore, the 360° visual field information is projected on the image capturing plane 64, thereby obtaining the all-direction image 21 as shown in FIG. 2.

In FIG. 6, a coordinate system is defined as follows. The intersection 0 of asymptotic lines 65 and 66 is an origin, a horizontal plane is formed by the X axis and the Y axis, and a vertical axis (a direction connecting between the first focus 62 and the second focus 63) is the Z axis. In such a coordinate system, a hyperboloidal surface is represented by

(X²+Y²)/a²−Z²/b²=−1 (1)

c²=(a²+b²) (2)

where a and b are numerical values (distances) determining the shape of the hyperboloidal surface, and c is a numerical value representing a distance from the intersection 0 of the asymptotic lines 65 and 66 to each focus 62 and 63.

FIG. 7 is a diagram showing a schematic configuration of a moving object tracking apparatus 2000 according to an example of the present invention. The moving object tracking apparatus 2000 includes a hyperboloidal mirror 70, a protection dome 71, a holder 72, a video camera 73, a camera holder 74, and an information processing section 90. The information processing section 90 includes a camera adapter 75, an image processing board 76, and a personal computer 77. In this example, an aluminum material is shaped and a resultant surface thereof is subjected to metal deposition, thereby obtaining a hyperboloidal mirror 70 having a diameter of 65 mm (a=17.93, b=21.43 and c=27.94). Further, the protection dome 71 made of acryl is attached to the hyperboloidal mirror 70, and the video camera 73 is attached via the holder 72 in order to capture information on the environment. The video camera 73 is supported by the camera holder 74 so as to prevent the camera 73 from falling.

In this construction, a viewing angle is obtained where the horizontal viewing angle is 360°, the vertical viewing angle is about 90°, the elevation angle is about 25°, and the depression angle is about 65°. Although in this example metal is shaped to produce the hyperboloidal mirror 70, a plastic material may be shaped using a mold, and a resultant surface thereof is subjected to metal deposition in mass production, thereby making it possible to reduce production cost.

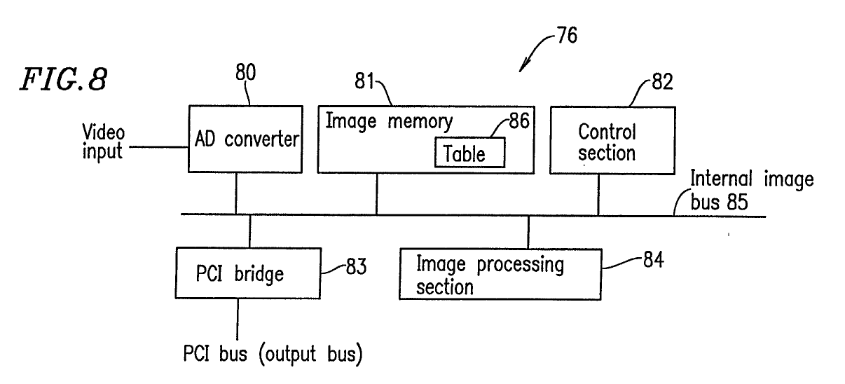

As an image capturing section (the video camera 73), a color CCD camera having f=4 mm and a resolution of 410,000 pixels is used. A video composite signal from the CCD camera is converted to an RGB signal by the camera adapter 75, and the RGB signal is stored in an image memory 81 (FIG. 8) in the image processing board 76 mounted in an extended slot of the personal computer 77. GPB-K manufactured by Sharp Semiconductor is used as the image processing board 76. This board includes a wide-range image processing library, and has an image processing rate of 40 nsec per pixel. Further, the personal computer 77 includes a Celeron 400 MHz as a CPU, a memory of 64 MB, and Windows NT as an OS, for example.

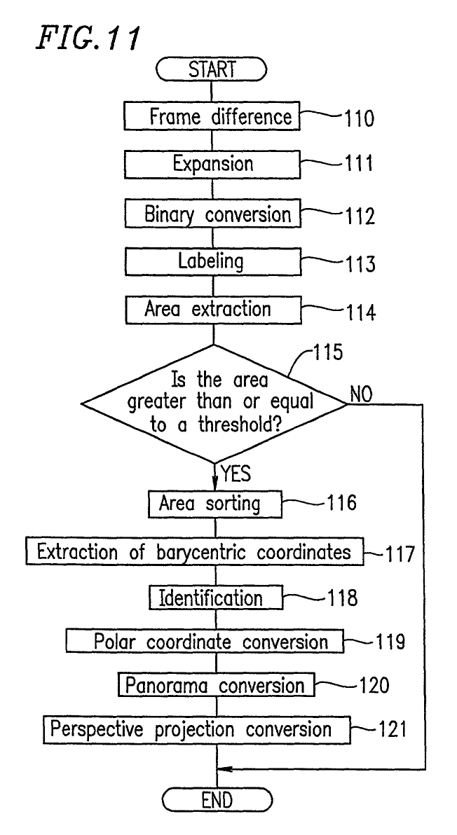

FIG. 8 is a diagram showing an internal structure block in the image processing board 76 of FIG. 7 and is used for explaining an operation of the internal structure block. All-direction image data converted to an RGB signal by the camera adapter 75 is converted to digital data having 8 bits in each color of R, G and B by an AD converter 80, and the resultant digital data is stored in an image memory 81. Data in the image memory 81 is transferred via an internal image bus 85 to an image processing section 84, and various kinds of image processing (FIG. 11) are performed using the above-described image processing library at high speed. Processed data is transferred via a PCI bridge 83 to a PCI bus of the extended slot of the personal computer 77 and is stored in a memory 77a of the personal computer 77. The data is displayed on a display 78. A keyboard 79 shown in FIG. 7 is a means for receiving commands to start and end the processes of the moving object tracking apparatus 2000. The control section 82 shown in FIG. 8 controls transmission and reception of host commands, the image memory 81, and the image processing section 84.

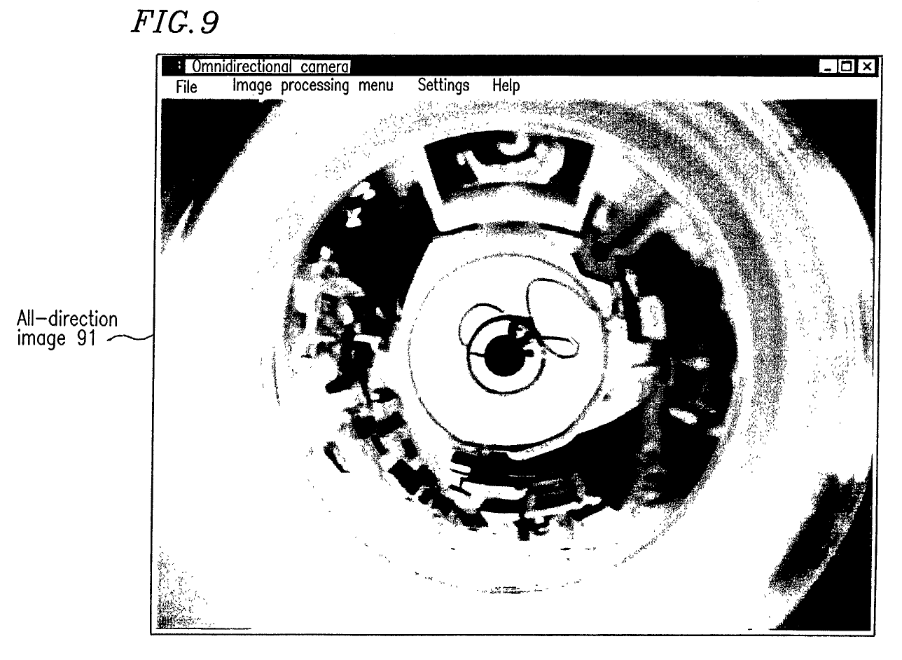

FIG. 9 shows a window of the display 78 displaying data stored in the memory 77a which is obtained by transferring all-direction image data captured in the image memory 81 of the image processing board 76 to the personal computer 77. The screen size of this window is a VGA screen of 640×480 pixels, for example. The window corresponds to the display screen 20 of FIG. 2. When the all-direction image 91 is displayed on a VGA screen having a resolution of 640×480 pixels, the resolution of 410,000 pixels of the CCD camera is sufficient. It should be noted that a camera having a higher resolution is required to increase the resolution of an image.

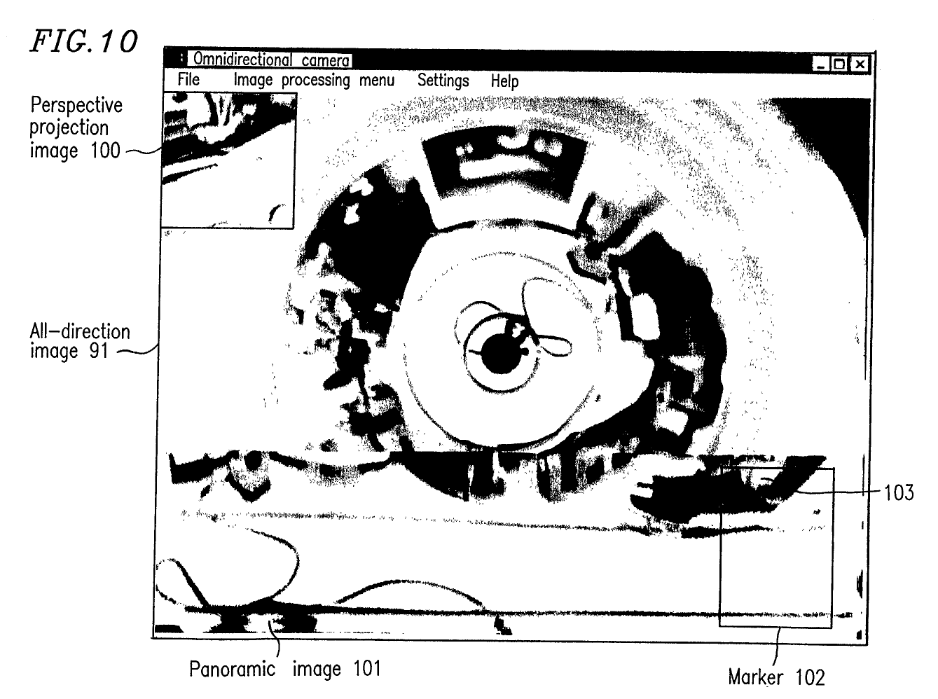

FIG. 10 shows the above-described window into which a panoramic image 101 obtained by subjecting the all-direction image 91 of FIG. 9 to panorama conversion and a perspective projection image 100 obtained by subjecting the all-direction image 91 to perspective projection conversion are integrated. In this case, the panoramic image 101 has a size of 640×160 pixels while the perspective projection image 100 has a size of 120×120 pixels. A marker 102 is given to a moving object 103 in the panoramic image 101.

Hereinafter, a process flow in which the moving object 103 is detected from the all-direction image 91 of FIG. 9, the marker 102 is given to the moving object 103, and the panoramic image 101 and the perspective projection image 100 are produced will be described with reference to FIG. 11.

All-direction image data is converted to an RGB signal by the camera adapter 75 of FIG. 7, the RGB signal is converted to digital data having 8 bits in each color of R, G and B by the AD converter 80 of FIG. 8, and the digital data is stored in the image memory 81. In step 110 of FIG. 11, all-direction image frame data captured in a previous frame and all-direction image frame data captured in a current frame are subject to a subtraction operation so as to calculate a frame difference.

As a postprocess of the frame difference or a preprocess of a subsequent binary conversion, a maximum pixel value in a 3×3 pixel window is determined in step 111. Thereby, the image is expanded. In this case, since a moving object is likely to be split into separate objects in a binary conversion, the expansion of the image is carried out in order to unite the separate objects.

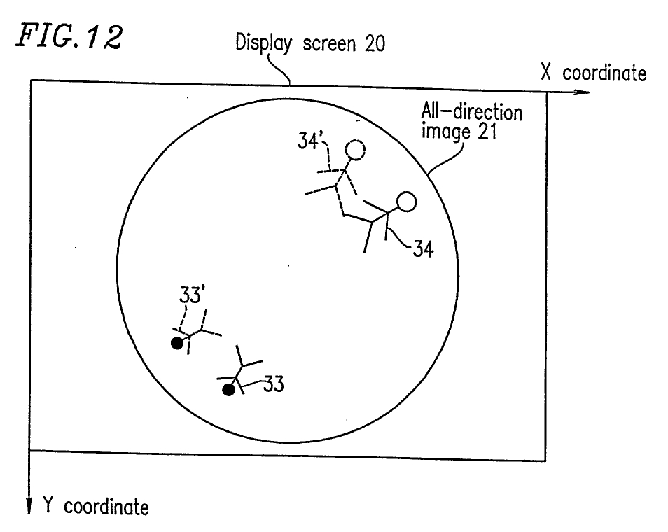

Thereafter, in step 112, an 256-gray level image is converted to a 2-gray level image having one gray level for a background and the other gray level for a moving object to be tracked. As a result of the frame difference calculation, the background having substantially no movement amount has a brightness difference of zero. The moving object has a brightness difference between a previous frame and a current frame, so that the brightness difference greater than or equal to a predetermined value is detected as a moving object. The moving object can be tracked by detecting such a brightness difference between each frame. Referring to FIG. 12, the positions of the moving objects 33 and 34 in the current frame are different from the respective positions of the moving objects 33′ and 34′ in the previous frame. Therefore, brightness differences are present at the positions of the moving objects 33, 34, 33′ and 34′. Moving objects can be tracked by detecting such brightness differences between each frame.

Thereafter, in step 113, connected regions in the binary image data are numbered (labeled). By labeling, the area or the center of mass of a connected region (described later) can be extracted for each label. Further, by labeling, a plurality of moving objects can be distinguished. In this example, as shown in FIG. 12, an X-Y coordinate system where the upper left corner is an origin is used as a coordinate system for the all-direction image 21 in a VGA screen of 640×480 pixels (the display screen 20).

Thereafter, in step 114, the area (the number of pixels) of each labeled connected region is calculated. In step 115, whether the area is greater than or equal to a threshold is determined. If the area is less than the threshold, the labeled connected region is determined as noise. Therefore, the process flow of the present invention is resistant to noise.

In step 116, the extracted areas are sorted in decreasing order of size. In step 117, the barycentric coordinates are calculated for each of the n largest areas. The barycentric coordinates of each connected region labeled in step 113 are calculated by a first-order moment calculated for the connected region being divided by the area (0-order moment). Thereafter, in step 118, the n sets of barycentric coordinates in a current frame extracted in step 117 and the n sets of barycentric coordinates in a previous frame are identified, thereby detecting moving objects and tracking each moving object.

In this manner, moving objects can be detected and the barycentric coordinates thereof can be calculated. Therefore, in step 119, a radius and an angle of each moving object in a polar coordinate system are calculated based on the barycentric coordinates thereof. Thereafter, in step 120, the all-direction image of a current frame is converted to a panoramic image. In step 121, the all-direction image of a current frame is converted to a perspective projection image. Further, in step 120, when the panorama conversion is carried out, a marker is given to a moving object detected in step 119. Thus, by giving a marker to a moving object, a plurality of moving objects in an all-direction image can be tracked without difficulty.

In the moving object detection flow from step 110 to step 119, only G data of RGB data may be used so as to speed up the detection processing of moving objects, for example. In step 120 and step 121, all RGB data are used so as to process a color image.

Thus, moving objects are detected from all-direction image data in a current frame, and the all-direction image data can be converted to panoramic image data and perspective projection image data having markers. The converted image data is stored in the memory 77a of the personal computer 77, and transferred to the display 78 on which the image data is presented (FIGS. 9 and 10). After the above-described process, a next all-direction image is captured and subsequent frame data is processed, so that a moving image can be displayed.

Hereinafter, methods for converting an all-direction image to a panoramic image and a perspective projection image in steps 120 and 121 will be described. Algorithms for panorama conversion and perspective projection conversion are disclosed Japanese Laid-Open Publication No. 6-295333, for example.

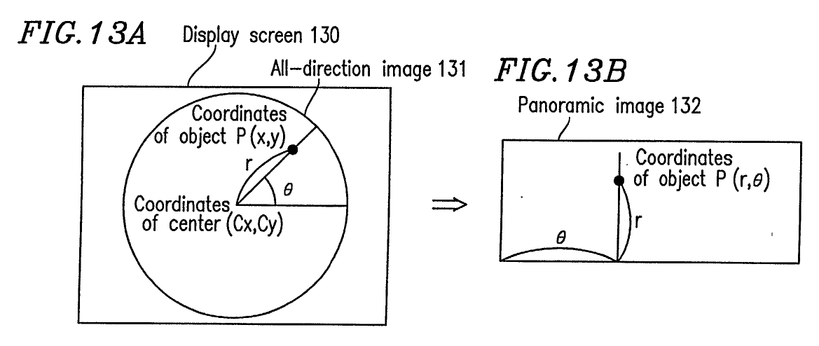

First, panorama conversion will be described with reference to FIGS. 13A and 13B. As disclosed in Japanese Laid-Open Publication No. 6-295333, an object P (pixel) represented by coordinates (x, y) in a display screen 130 shown in FIG. 13A can be projected to a panorama screen 132 shown in FIG. 13B by calculating a radius r and an angle θ of the object P in an all-direction image 131 where the coordinates of the center of the all-direction image 131 is (Cx, Cy). However, to perform such a conversion operation for each pixel is time-consuming. Therefore, in this example, the coordinates in the all-direction image 131 calculated based on the coordinate system of the panoramic image 132 corresponding to all pixels in the panoramic image 132 are previously prepared as a table 86 (FIG. 8), and panorama conversion is carried out only by referencing the table 86. The table 86 is stored in the image memory 81, for example.

Specifically, a pixel designated as (r, θ) in the panoramic image 132 is represented in the all-direction image 131 by (x, y), i.e.,

x=Cx+r×cosθ (3)

y=Cy+r×sinθ (4).

In the table 86, for the radius r and the angle θ of each pixel in the panoramic image 132, a corresponding x coordinate is calculated in advance in accordance with formula (3) and a corresponding y coordinate is calculated in advance in accordance with formula (4). These x and y coordinates are stored in respective tables tbx and tby. In this case, the angle θ ranges from 0° to 360° in 1/100° steps and the radius r ranges from 0 pixel to 160 pixels. Therefore, the size of the panoramic image 101 is 160 pixels in a lengthwise direction as shown in FIG. 10.

It should be noted that a pan operation can be performed in the panoramic image 132 by adding an offset to each angle θ when preparing the table. Therefore, such a pan operation can be performed in the panoramic image 132 at high speed by image processing. As to a marker adding operation, since the radius and the angle of a moving object are determined in step 119 (FIG. 11), a marker is displayed (added) at a corresponding portion in a panoramic image based on such information.

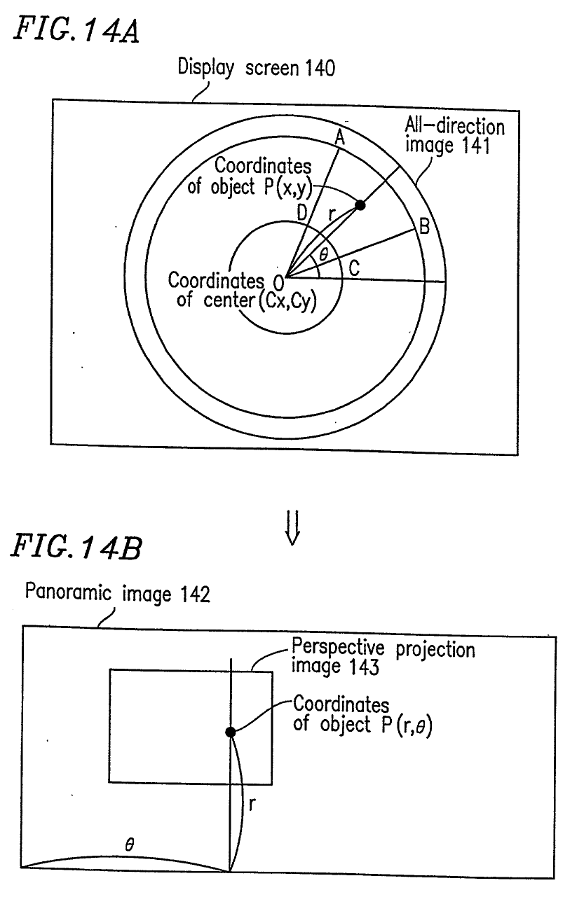

Hereinafter, perspective projection conversion will be described with reference to FIGS. 14A and 14B. For example, a sector portion surrounded by A, B, C and D in an all-direction image 141 on a display screen 140 shown in FIG. 14A is subjected to perspective projection conversion. A radius r and an angle θ of an object P (pixel) designated as coordinates (x, y) with reference to the coordinate of the center (Cx, Cy) of the all-direction image 141 are determined. Thereby, the sector portion is projected onto a panoramic image 142 as a perspective projection image 143 as shown in FIG. 14B. However, to perform such a conversion operation for each pixel is time-consuming. Therefore, in this example, as described above for the panorama conversion, the coordinates in the all-direction image 141 corresponding to all pixels in the panoramic image 142 are previously prepared as the table 86 (FIG. 8), and perspective projection conversion is carried out only by referencing the table 86.

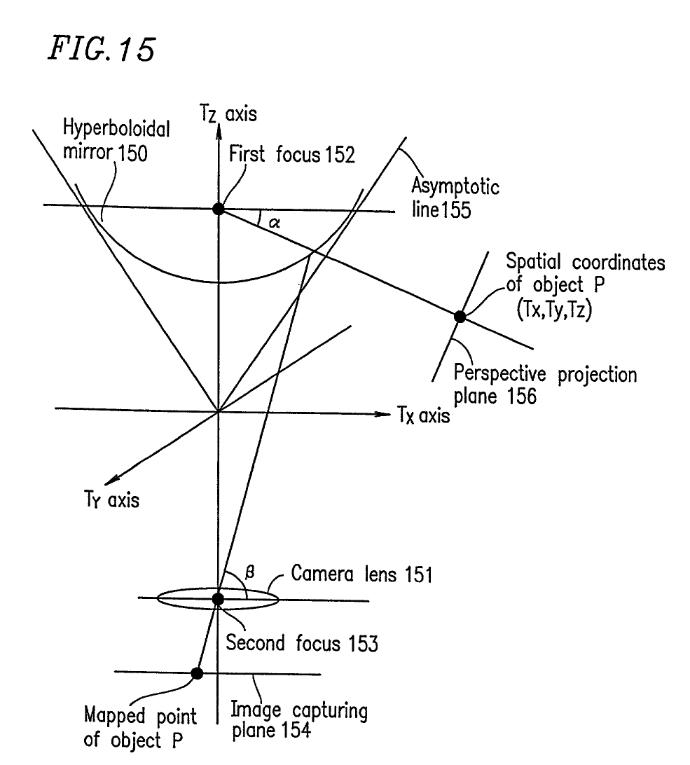

Specifically, as shown in FIG. 15, it is assumed that there is a perspective projection plane 156 containing an object P in a three-dimensional space where the coordinates of the object P are (Tx, Ty, Tz). It is also assumed that an image of the object P is seen in an all-direction image 141 on an image capturing plane 154 of the video camera 73 (FIG. 7). In this case, the polar coordinates (r, θ) of the object P (pixel) in the all-direction image 141 on the perspective projection plane 156 are obtained using the table 86. Thereafter, by referencing the above-described x-coordinate table tbx and the y-coordinate table tby, coordinates (x, y) in the all-direction image 141 are obtained, thereby making it possible to perform perspective projection conversion.

Specifically, a pixel represented by coordinates (r, θ) in the perspective projection image 143 (FIG. 14B) is converted to coordinates (x, y) in the all-direction image 141 using formulas (3) and (4). As shown in FIG. 15, the radius r and the angle θ in the perspective projection image 143 are represented by

α=arctan(Tz/sqrt(Tx²+Ty²)) (5)

β=arctan(((b²+c²)×sinα−2×b×c)/(b²−c²)×cosα) (6)

where the three-dimensional coordinates of the object P are (Tx, Ty, Tz), an angle of the object P viewed from a first focus 152 of a hyperboloidal mirror 150 with respect to a Tx axis is α, an angle of the object P projected on the hyperboloidal mirror 150 viewed from the center of a camera lens 151 of the video camera 151 with respect to the Tx axis is β, and a, b and c are numerical values determining the shape of the hyperboloidal mirror 150 and satisfying formulas (1) and (2). The radius r and the angle θ also satisfy

θ=arctan(Ty/Tx) (7)

r=F×tan((π/2)−β) (8)

where F is the focal distance of the camera lens 151.

A radius r and an angle θ are calculated in advance for a set of coordinates (Tx, Ty, Tz) corresponding to each pixel on the perspective projection plane 156 in accordance with formulas (7) and (8) to prepare a θ-coordinate table tbθ and a r-coordinate table tbr as a portion of the table 86. In this example, the size of the perspective projection plane 156 is 120×120 pixels as described above, for example. Therefore, this size corresponds to the viewing angle obtained when assuming the video camera 73 is placed at the first focus 152 of the hyperboloidal mirror 150.

Therefore, each pixel on the perspective projection plane 156 can be converted to polar coordinates (r, θ) on the all-direction image 141 only by referencing the table tbθ and the table tbr. Thereafter, the polar coordinates (r, θ) are converted to coordinates (x, y) on the the all-direction image 141 only by referencing the table tbx and the table tby.

A pan operation can be performed in the perspective projection image 143 by adding an offset to an angle θ when producing the table tbθ, as in the panoramic image 142. A tilt operation can also be performed in the perspective projection image 143 by preparing a specialized table tbtr of a radius r. The tilt table tbtr lists a radius obtained by formulas (6) and (8) with respect to an angle α obtained by a tilt angle. Therefore, a pan operation and a tilt operation of the perspective projection image 143 can be performed by image processing at high speed.

As described above, in this example, the processes in steps 110 to 114 and step 117 of FIG. 11 are performed using functions included in an image processing library contained in an image processing board. The detection of a moving object is performed using only G data of RGB data. An all-direction image is converted to a panoramic image or a perspective projection image using a plurality of tables previously prepared. Therefore, a moving image processing having a rate of 10 frames per second can be obtained in this example. In order to obtain moving image processing having a rate of 30 frames per second, for example, an image processing board having a processing rate three times that of the above-described image processing board is required. The processes in steps 115, 116, 118 and 119 may be performed by a CPU of a personal computer rather than an image processing board.

As described above, according to the present invention, an optical system including a hyperboloidal mirror and a stationary camera are used instead of a mechanical driving portion. Therefore, maintenance is substantially not required during long-time operation, and highly reliable and stable operation can be realized. Further, only one camera is required, resulting in an inexpensive moving object tracking apparatus. Furthermore, visual field information on the 360° environment can be captured simultaneously. Therefore, losing track of a moving object is unlikely, and it is also possible to track a moving object which moves around the camera.

An all-direction image obtained by using a hyperboloidal mirror in an optical system can be converted to a panoramic image so as to be easily viewed, or to a perspective projection image to obtain an image substantially without distortion. Therefore, recognition precision of a moving object can be improved. The moving object tracking apparatus of the present invention can be used in various applications, such as an indoor or outdoor surveillance apparatus, in a locomotive robot, and in a vehicle.

Detecting and tracking a moving object can be realized by the above-described simple algorithms. The modification of a viewing angle, such as pan or tilt, can be performed. Further, complicated circuitry for controlling the movements of a camera as in the conventional technology is not required. Therefore, the entire system can be made simple. A moving object tracking apparatus handling color moving images can also be made small.

According to the present invention, image information processing is carried out using a conversion table previously prepared depending on the resolution of a captured image, thereby speeding up image information processing. Further, color moving images can be processed at high speed by subjecting one color data of RGB data to image processing.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A moving object tracking apparatus for detecting and tracking one or more moving objects in an environment, comprising:
an optical system including a hyperboloidal mirror for capturing visual field information on a 360° environment;
a single stationary camera for converting the captured visual field information to image information; and
an information processing section for processing the image information,
wherein the information processing section detects and tracks the one or more moving objects based on the image information.

2. A moving object tracking apparatus according to claim 1, wherein:
the image information includes all-direction image information; and
the information processing section converts at least a portion of the all-direction image information to panoramic image information.

3. A moving object tracking apparatus according to claim 2, wherein the information processing section provides a marker to each of the one or more moving objects in the panoramic image information.

4. A moving object tracking apparatus according to claim 3, wherein the information processing section provides a marker to each of the one or more moving objects depending on a size of each of the one or more moving objects.

5. A moving object tracking apparatus according to claim 1, wherein:
the image information includes all-direction image information; and
the information processing section converts at least a portion of the all-direction image information to perspective projection image information.

6. A moving object tracking apparatus according to claim 1, wherein the information processing section processes the image information using a previously prepared table.

7. A moving object tracking apparatus according to claim 1, wherein the information processing section processes the image information using only one kind of data out of RGB data in the image information.

8. A moving object tracking apparatus according to claim 1, wherein the information processing section detects the one or more moving objects based on a brightness difference between predetermined frame information and frame information previous to the predetermined frame information of the image information.
